(19) United States
(12) Patent Application Publication
(10) Pub. No.: US 2018/0322194 A1
(43) Pub. Date: Nov. 8, 2018

(54) MULTI-SOURCE MEDIA CONTENT SEARCH

(71) Applicant: Hey Platforms DMCC, Dubai (AE)

(72) Inventors: Nadim Basha bin Mohamed Al Qubaisi, Dubai (AE); Anthony Webb, Dubai (AE); Anthony Stephen Clarke, Dubai (AE); Darryl Haydn Jones, Dubai (AE)

(21) Appl. No.: 15/585,437

(22) Filed: May 3, 2017

(51) Int. Cl. G06F 17/30; G06F 3/0484; G06F 3/16

(52) U.S. Cl. CPC G06F 17/30761; G06F 3/04842; G06F 3/165; G06F 17/30029; G06F 17/30038

(57) ABSTRACT

A media content search and retrieval identifies a plurality of available sources for media content such as songs and music videos, and renders the media content in conjunction with supporting and/or related information that complements and enhances the user experience. The media search implements a cross-source search engine and approach which navigates multiple content sources based on the same search label or title, and identifies the most preferable or beneficial source based on an overhead burden imposed by each of the sources. Found content is rendered by both streaming the audio and/or video content from the found source, and integrating with supporting information aggregated on an appurtenant media server. A local device app receives both the content stream and the supporting information cached or stored on the media server for efficient rendering of the enhanced media content.

### BACKGROUND

Media players are a common and popular addition to mobile devices, as well as other types of computer rendering devices. Internet sites available for download of media, such as music, videos and full length films, are plentiful and growing. Many sites promote media such as music selections on a fee-for-services, while others allow less restrictive access. Evolution of these types of sites, as well as the types and format of available media has been rapid and generally unstructured. Accordingly, there are many storage and encoding formats available for rendering streamed audio and video content, in addition to the access restrictions noted above. A search label such as a song title, musical artist or group, or film often results in many “hits”, or search results purporting to satisfy a query.

### SUMMARY

A media content search and retrieval identifies a plurality of available sources for media content such as songs and music videos, and renders the media content in conjunction with supporting and/or related information that complements and enhances the user experience. The media search implements a cross-source search engine and approach which navigates multiple content sources based on the same search label or title, and identifies the most preferable or beneficial source based on an overhead burden imposed by each of the sources. Found content is rendered by both streaming the audio and/or video content from the found source, and integrating with supporting information aggregated on an appurtenant media server. A local device app receives both the content stream and the supporting information cached or stored on the media server for efficient rendering of the enhanced media content.

Configuration herein are based, in part, on the observation that multiple sources often exist for the same content item. Unfortunately, conventional approaches to media content searching can indiscriminately return search results of many possible sources, along with extraneous and tangentially related information that must also be navigated to identify the available sources. Conventional search results do not indicate which result entries refer to pay-for-services or password/account registration mandated sites, other fees or encumbrances, and delivery attributes such as speed, quality and network distance. Accordingly, configurations herein substantially overcome the above-described shortcomings by providing a cross-source search engine and method that coalesces search results from multiple sources to identify the most optimal, lowest overhead content source for streaming, and integrates supporting information related to the song title or artist into the user device rendering via an application (app) on the user device.

In conventional media search approaches, when searching for a particular piece of music, video, or other media, search results from GOOGLE®, BING®, YAHOO®, and other common search engines may be inefficiently ordered, presenting difficulty in finding exactly what the user wants. On the other hand, searching on service such as YouTube limits the range of to just those of that service. The disclosed approach implements a search engine for searching across the most common media services and brings the results together in a way a user can quickly identify the desired media content. In addition, the cross-source search can suggest alternative sources for media that would otherwise require a subscription. For example, providing a YOUTUBE® link for a song on SPOTIFY®.

In further detail, in the media rendering system for integrating media sources and supporting information provides a method for identifying media entities by receiving a search label, such that the search label is indicative of media content sought based on a user input request, and receiving, from a plurality of search sources, search results indicative of potential matches of the search label resulting from invocation of external search engines. A media server filters the search results for search entries pertaining to renderable content, either streaming or textual/pictorial information that may be screen displayed. The media server designates, for each filtered search entry, content entries and supporting entries, in which the content entries are indicative of stream sources of the media content and the supporting entries are indicative of unitary information segments. A search interface determines, from among the content entries, an invoked content entry for which streaming will be performed, such that the invoked content entry is determined based on transmission overhead and other optimization factors, and a user device simultaneously renders the invoked content entry and at least a subset of the supporting entries as available screen rendering area and media running time permit.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a rendering environment suitable for use with configurations herein;

FIG. 2 is a data flow of search results in the environment of FIG. 1;

FIG. 3 is a block diagram of application and server operation using the data flow of FIG. 3.

### DETAILED DESCRIPTION

Configurations depicted below present example embodiments of the disclosed approach in the form of a mobile device having an application (app) for implementing the media search and retrieval system and method disclosed herein. Particular approaches and configurations provide a system and method to aggregate related search content across multiple source platforms, and a method to find alternative legal sources for media that is behind a paywall or other network burden. The disclosed media server also facilitates presentation of related media search results in a manner more appropriate and easily navigable than conventional search engines.

Alternate configurations may allow combining discovered search results with information from alternate data sources, such as artist blogs and Wikipedia, to create a more robust search experience for users, and for facilitating creation of playlists out of discovered content, as disclosed in copending U.S. Patent Application <HPL16-02>, filed concurrently.

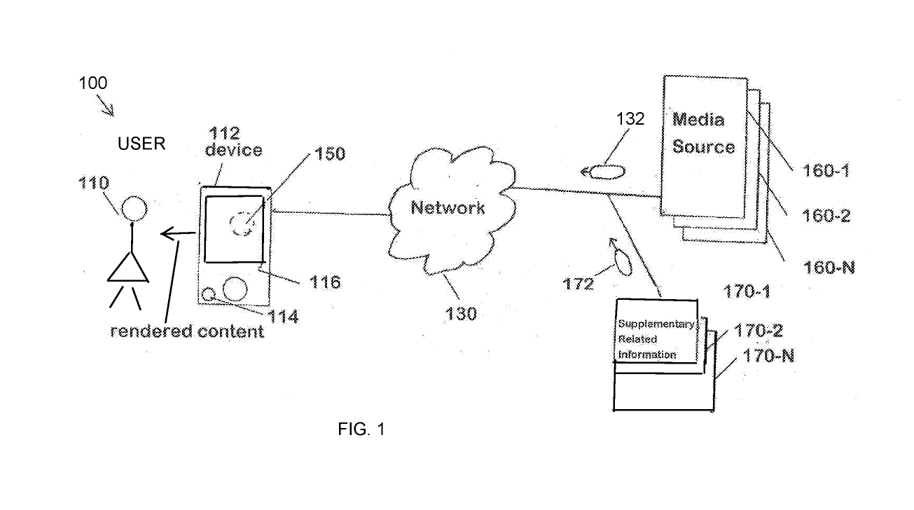

FIG. 1 is a context diagram of a rendering environment suitable for use with configurations herein. Referring to FIG. 1, in a rendering environment 100 a user 110 employs a personal device 112 such as a mobile phone, smart phone, tablet, laptop or other personal mobile or stationary electronic device suitable for rendering audio and video streams. The personal device 112 connects to a public access network 130 such as the Internet by any suitable wired or wireless mechanism, and includes an application (app) 150 for receiving media content and rendering audio and video via a respective speaker 114 and screen 116, as such personal devices 112 are often employed for.

The app 150 receives content 132 from a plurality of media sources 160-1 . . . 160-N (160 generally) via the network 130. Content 132 includes various media such as audio, video, or a combination. In addition to streamed audio often requested by conventional devices, the app 150 also receives streamed video from the sources 160, and also receives related or supporting information 172 and static content such as lyrics, news, blog entries and other information based on or related to the content from other remote information sources 170-1 . . . 170-N (170 generally), typically website search results. The app 150 receives the content 132 (typically streamed) and related information sources 172 (typically static or text entries), and renders both in a unified manner on the device 112.

The content 132 is received by a player or rendering app for properly that content 132 by playing/displaying the song/video. The app 150 includes media player based on the media source 160 and type of the media content 132.

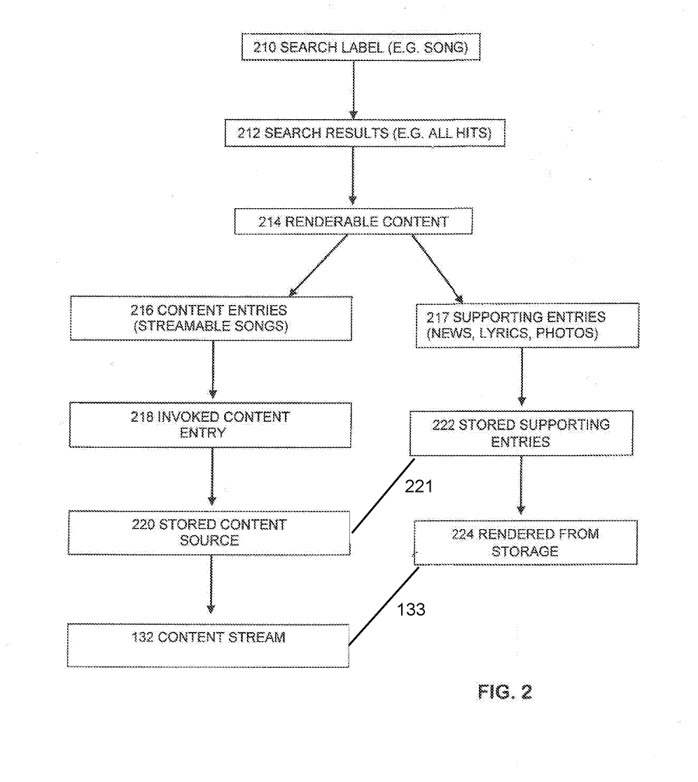

FIG. 2 is a data flow of search results in the environment of FIG. 1. Referring to FIGS. 1 and 2, a search label 210 such as a song title is received by the app 150, typically in response to user input. Search results 212 based on the search label 210 include found Internet entries, or “hits.” The search may also include results based on user profiles, user generated event information (and ticketing), third party event information (and ticketing), and results from user generated playlists. The search results 212 are filtered to designate renderable content 214. The renderable content is either content suitable for streaming or supporting information adapted for audible or video rendering. Once the content is deemed sufficiently pertinent to the search label 210, it is subdivided into content entries 216 and supporting entries 217. A content entry 216 is a reference to media content 132, such as a URL (Uniform Resource Locator) of the data for streaming. A supporting entry 218 is a reference to supporting information, such as news, lyrics and pictures. Further streamed media may also be included if it is to be rendered simultaneously with the media content 132.

For the content entries 216, an invoked content entry 218 indicative of the best or preferred source for streaming is selected and stored 220. The stored invoked content entry 218 is an identifier to the source 220 of the media content 132, not the actual content. Upon demand, the media content 132 referenced by the invoked content entry 218 is streamed to the personal device 112.

For the supporting entries 217, transmission and storage of the actual supporting information 222 is performed, and stored in conjunction with the stored source 220, as shown by dotted line 221. This allows concurrent rendering of the supporting information 172 along with the rendering streaming of the content 132 to the device 112, as shown by dotted line 133. The content entry 218 may also be stored as a media entry in a playlist containing a plurality of media entries referring to media content suitable for initiating streamed response, as disclosed in copending U.S. Patent Application <HPL16-02>.

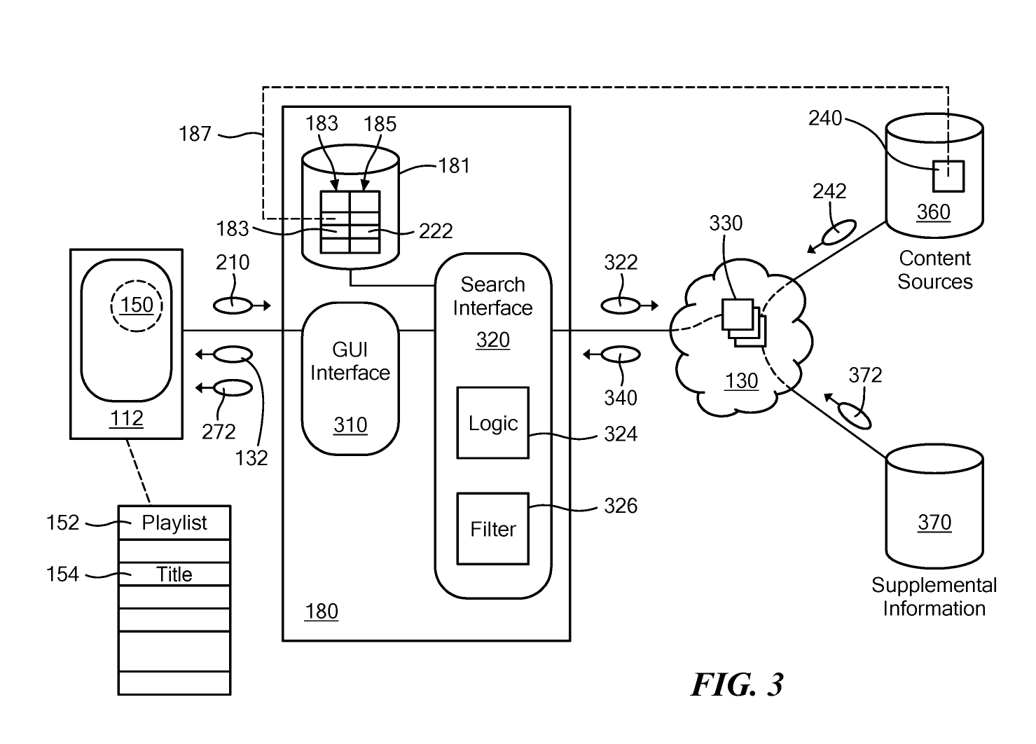

FIG. 3 is a block diagram of app 50 and media server 180 operation using the data flow of FIG. 3. Referring to FIGS. 1-3, in a typical usage, a search label 210 is received via the application 150 on the user device 112. The search label 210 is typically a song title, but may be any content entry suitable for searching, such as a musical group or artist, movie title, character, etc. A media server 180 in communication with the app 150 receives the search label 210 and commences a search operation as in FIG. 2 for identifying the renderable content 214.

A GUI interface 310 receives the search label 210 from a displayed search screen on the device 112, and invokes a search interface 320 for identifying the relevant renderable content 214. The media content 240 is the file with the audio and/or video data adapted for streaming as streamed media 132. As indicated above, the sought renderable content 214 includes the streamed media content itself (such as audio data containing the melody and lyrics) and the supporting information which is, typically but not necessarily, static information such as textual lyrics, pictures, and news. Thus, in a typical configuration, the search label 210 is title of song, video or film, and the supporting entries are static file entries based on the media content referenced by the search label 210. From the search label 210, the search interface 320 invokes external search engines 330 such as GOOGLE®, BING® and others using search terms 322 intended to target renderable content pertaining to the search label 210. From the search, search results 340 will include comingled references to content entries 242 and supporting entries 372. The search interface 320 includes logic 324 and a filter 326 for coalescing and refining the search results 340 as in FIG. 2. The search may further segregate or designate different results between sources such as YouTube, Spotify etc., to designate a preference due to a subscription or user choice.

Conventional search results tend to include a myriad of tangentially related and/or undesirable and extraneous material, due to the nature of keyword searching. The filter 326 identifies the renderable content by filtering the search results containing material suitable for rendering. Filtering is based on a proximity of the search terms 322, in which that search terms are derived from the search label 210, and further on a file type of the search result. Typical anomalies in keyword searching result from keyword terms that appear distant or out of context, that “fool” the search logic. Types of files referenced by the search results 340 are also considered, as not all file types are suitable for rendering. Therefore, filtering the search results 340 yields search entries pertaining to renderable content.

Following filtering, the logic 324 subdivides the resulting renderable content 214 into entries that reference the content sources 360 suitable for streaming, and the supporting information 370. This may be performed by examining file type extensions, and also by parsing a file to identify data structures or sequences corresponding to the type of date therein. The logic 324 designates, for each filtered search entry, content entries 216 and supporting entries 217, such that the content entries are indicative of stream sources 360 of the media content 240 and the supporting entries 372 are indicative of unitary information segments that may be rendered alongside the media content.

Often, multiple sources 360 are available for providing the same media content 240, varying based on a free or pay-for-services access manner, as well as transmission overhead and other factors that make some content sources more appealing or beneficial than others. Transmission overhead includes factors such as paywall, transmission speed and network distance, as well as other factors affecting ease of uninterrupted streaming delivery. Identification of alternate sources for media sought by a user enhances the user experience by reducing cost and increasing reliability of the streamed media to avoid dropouts and decoding anomalies.

In the approach disclosed herein, the streamed media content 132 is reference by an identifier, and streamed directly to the device 112, as shown by dotted line 187, rather than a two phase download and store approach. Therefore, copyright concerns are mitigated since the sought media is not copied or stored, but rather streamed directly based on a URL reference to the source 360. However, the supporting information 370 may be stored or cached on the media server 180, also subject to license and/or copyright restrictions promulgated by the owner. For example, some sources 370 provide an hourly limit to the time a supporting entry 218 may be stored. Similarly, media rendering will not obfuscate advertising or watermarks intended to be conveyed by the copyright owner, licensee, or contractual oblige of the rendered media, so as to avoid deterring usage from fear of undermining property rights of others.

When multiple viable sources 360 are found for the media content 240, the logic 324 determines, from among the content entries 216, an invoked content entry 218 from which streaming will be performed, such that the invoked content entry is determined based on the transmission overhead, as discussed above. For example, determining the invoked content entry may include identifying a first content entry from a first search source and a second content entry from a second search source, and determining that the first search source imposes cost or copyright burdens. The logic performs a comparison to identify a preference when multiple viable sources 360 of media content 240 from which to select the content entry 216 for streaming. The logic 324 therefore designates the second content entry as the invoked content entry 218 for rendering.

The user experience entails coupling the streaming media 242 with the supporting entries 372 having related information or media. Prior to rendering the invoked content entry, the logic 324 stores the supporting entries on the local media server 180 in a local storage device 181, and stores the content entries 242 with the supporting entries 372 in content entry storage 183 and supporting information storage 185, respectively. Recall that stored content entry in 183 is a reference 187 or pointer (i.e. URL) to the actual media content 240. Upon playback or rendering to the user, media content 132 is streamed from the network location designated by the stored content entry 220 concurrently with rendering at least one of the supporting entries 222 on the user rendering device 112. Alternatively, local storage may be fulfilled by emerging and future storage mediums such as Trans Flash, dynamic memory such as cloud storage, and any suitable storage technology now known or later developed is suitable for storage of the homogeneous playlist.

It should be noted that the user rendering device 112 also represents any suitable consumer of the rendered media content as disclosed herein. The media content may be received and consumed (rendered) by any suitable device (mobile, laptop, tablet, desktop, etc) and may be received by a browser implementing the disclosed approach, or by an app (application) configured for receiving and rendering. Both an app and a browser executing an HTML or Java application, for example, are configurable for consuming renderable media content as described below.

Rendering of the media content 240 therefore further includes streaming the invoked content entity 218 to a mobile device such as the user rendering device 112, and concurrently transmitting the supporting entries 272 to the mobile device for display and playback concurrently with the streamed content. Media content 240 referenced by each content entry 242 may be rendered the content stream 132, along with a plurality of supporting entries 272, in which the supporting entries each have a predetermined interval and are concatenated based on the predetermined interval and a rendering duration of the media content. The logic 324 can determine the play length of the song, and apportions the supporting entries 272 in a sequence of time intervals to distribute the supporting entries over the play length. A playlist 152 may have an entry 154 to reference the content by title or label.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a media rendering system for integrating media sources and supporting information for media content, a method for identifying media entities, comprising:
receiving a search label, the search label indicative of media content sought based on a user input request;
receiving, from a plurality of search sources, search results indicative of potential matches of the search label resulting from invocation of external search engines;
filtering the search results for search entries pertaining to renderable content;
designating, for each filtered search entry, content entries and supporting entries, the content entries indicative of stream sources of the media content and the supporting entries indicative of unitary information segments;
determining, from among the content entries, an invoked content entry for which streaming will be performed, the invoked content entry determined based on transmission overhead; and
simultaneously rendering the invoked content entry and at least a subset of the supporting entries.

2. The method of claim 1 wherein determining the invoked content entity further comprises:
identifying a first content entry from a first search source and a second content entry from a second search source;
determining that the first search source imposes cost or copyright burdens; and
designating the second content entry as the invoked content entry.

3. The method of claim 1 further comprising, prior to rendering the invoked content entry:
storing the supporting entries on a local media server;
storing the content entries with the supporting entries; and
streaming the content from a network location designated by the content entry concurrently with rendering at least one of the supporting entries on a user rendering device.

4. The method of claim 3 wherein rendering further comprises:
streaming the invoked content entity to a mobile device; and
transmitting the supporting entries to the mobile device for display and playback concurrently with the streamed content.

5. The method of claim 4 wherein media content from each content entry is rendered with a plurality of supporting entries, the supporting entries each having a predetermined interval and concatenated based on the predetermined interval and a rendering duration of the media content.

6. The method of claim 3 wherein the transmission overhead includes paywall, transmission speed and network distance.

7. The method of claim 3 wherein the search label is title of song, video or film, and the supporting entries are static file entries based on the media content referenced by the search label.

8. The method of claim 3 wherein the media content is the file with the audio and/or video data adapted for streaming.

9. The method of claim 1 wherein filtering is based on a proximity of search terms, the search terms derived from the search label, and further on a file type of the search result.

10. A media rendering server, comprising:
a GUI (graphical user interface) configured to receiving a search label, the search label indicative of media content sought based on a user input request;
a search interface for receiving, from a plurality of search sources, search results indicative of potential matches of the search label resulting from invocation of external search engines via a public access network;
a filter for filtering the search results for search entries pertaining to renderable content;
logic for designating, for each filtered search entry, content entries and supporting entries, the content entries indicative of stream sources of the media content and the supporting entries indicative of unitary information segments, the logic configured to determine, from among the content entries, an invoked content entry for which streaming will be performed, the invoked content entry determined based on transmission overhead; and
the GUI interface coupled to a mobile device for simultaneously rendering the invoked content entry and at least a subset of the supporting entries.

11. The device of claim 10 wherein the logic is further configured to:
identify a first content entry from a first search source and a second content entry from a second search source;
determine that the first search source imposes cost or copyright burdens; and
designate the second content entry as the invoked content entry.

12. The device of claim 10 further wherein the media server is configured to:
store the supporting entries on a local media server;
store the content entries with the supporting entries; and
providing a network location to a user rendering device for streaming the content designated by the content entry concurrently with transmitting at least one of the supporting entries for rendering on the user rendering device.

13. The device of claim 12 further comprising a media stream referenced by the invoked content entity and directed to a mobile device; and
a transmission of the supporting entries to the mobile device for display and playback concurrently with the streamed content.

14. The device of claim 13 wherein media content from each content entry is rendered with a plurality of supporting entries, the supporting entries each having a predetermined interval and concatenated based on the predetermined interval and a rendering duration of the media content.

15. The device of claim 12 wherein the transmission overhead includes paywall, transmission speed and network distance.

16. The device of claim 12 wherein the search label is title of song, video or film, and the supporting entries are static file entries based on the media content referenced by the search label.

17. The device of claim 12 wherein the media content is the file with the audio and/or video data adapted for streaming.

18. The device of claim 10 wherein filtering is based on a proximity of search terms, the search terms derived from the search label, and further on a file type of the search result.

19. A computer program product having instructions encoded on a non-transitory computer readable storage medium that, when executed by a processor, perform a method for identifying media entities, the method comprising:
receiving a search label, the search label indicative of media content sought based on a user input request;
receiving, from a plurality of search sources, search results indicative of potential matches of the search label resulting from invocation of external search engines;
filtering the search results for search entries pertaining to renderable content;
designating, for each filtered search entry, content entries and supporting entries, the content entries indicative of stream sources of the media content and the supporting entries indicative of unitary information segments;
determining, from among the content entries, an invoked content entry for which streaming will be performed, the invoked content entry determined based on transmission overhead; and
simultaneously rendering the invoked content entry and at least a subset of the supporting entries.

20. The computer program instructions of claim 19 wherein determining the invoked content entity further comprises:
identifying a first content entry from a first search source and a second content entry from a second search source;
determining that the first search source imposes cost or copyright burdens; and
designating the second content entry as the invoked content entry.
